(19) United States
(12) Patent Application Publication
(10) Pub. No.: US 2009/0276089 A1
(43) Pub. Date: Nov. 5, 2009

(54) APPARATUS FOR DISPENSING LUGGAGE RECOGNITION LABELS AND METHODS FOR USE

(76) Inventor: Julie Robin Bartholomew, Birmingham, MI (US)

Correspondence Address: Angela M. Brunetti, 11300 E. Caribbean Lane, Scottsdale, AZ, 85255, US

(21) Appl. No.: 12/419,354

(22) Filed: Apr. 7, 2009

Related U.S. Application Data
(60) Provisional application No. 61/042,879, filed on Apr. 7, 2008.

(51) Int. Cl. G06F 17/00; G06Q 20/00; G06Q 50/00; G06Q 40/00; G06Q 10/00; H04Q 5/22

(52) U.S. Cl. 700/235; 705/17; 40/6; 705/4; 705/5; 235/375; 340/10.1

(57) ABSTRACT

An apparatus and a method for dispensing a luggage recognition label having an RFID or GPS device associated therewith that allows a passenger and/or a passenger carrier to identify and track their luggage during travel, provide access to a secure network for storing customer information and travel information including a luggage inventory and itinerary information, and the ability to purchase travel insurance in association with the luggage recognition label.

### CROSS REFERENCE

This application claims the benefit of the filing date of U.S. Provisional Application Ser. No. 61/042,879 filed Apr. 7, 2008, entitled “Apparatus for Dispensing Luggage Recognition Labels and Methods for Use” the entire disclosure of which is hereby incorporated by reference into the present disclosure.

### TECHNICAL FIELD

The present invention relates to dispensing luggage recognition labels and using the labels for identification and tracking purposes by passengers and passenger carriers.

### BACKGROUND

Each passenger carrier in the travel industry employs a system and method for ensuring luggage is handled appropriately using labels, scanners, readers, etc. to identify, sort, trace and process passenger luggage from a point of departure to arrival at an intended destination. All passenger carriers have very similar methods of identifying the luggage for a particular passenger. Each carrier has a unique Departure Control System (DCS) number assignment associated with its own carrier system. A standard label is printed out at the time the passenger checks in for a destination with the passenger carrier, so that one passenger carrier's labels are not easily distinguished from another passenger carrier's labels. The printed label is distinguishable only by small markings, typically a bar code, that are visibly identifiable as being unique unless scanned by a bar code reader.

The printed label bar code system, utilized within the travel industry today has proven to be inaccurate and is often subject to possible reading inconsistencies resulting from damage to the bar code label from dust, dirt, water, or simply immediate wear and tear that occurs during handling of the luggage. The inconsistencies that result from reading such a damaged tag makes identifying a bag nearly impossible, and locating a lost bag is a stressful, confusing, frustrating, and sometimes a hopeless experience for a passenger.

Complimentary tags are often provided by a passenger carrier on which a passenger can write-in their personal contact information to identify their own bag at the point of destination. However, the complimentary tags, while being disposable, are typically all the same color, quite small, and easily damaged, which does nothing to ease the process of recognizing luggage at a point of destination. The tag is typically attached to a luggage handle by a thin string or elastic band. The means for attaching the tag is subject to breakage during the luggage handling process. Further, there is no link, informational or otherwise, between the information provided on the complimentary tag filled out by the passenger and the tracking label printed out by the passenger carrier. Regardless of whether a passenger carrier is an airline, a railroad, a bus, or a cruise ship, once the luggage is at its intended destination, a passenger must recognize their own luggage form a large group of luggage, that have all been tagged in the same, or similar, fashion.

The luggage industry has taken care to provide passengers with a luggage product that is durable and can withstand potentially rough handling experienced during travel. This is beneficial to consumers, but there is a drawback in that there are a limited number of styles, sizes, shapes, colors and materials used in the luggage industry. Most pieces of luggage are remarkably similar in size, shape and color. Therefore, the passenger carrier's system for luggage handling is useless to a passenger when they are trying to recognize their bag and distinguish it from a multitude of luggage at their point of destination. The similarity in luggage, large crowds, and passenger fatigue are factors that add to the confusion for a passenger attempting to identify luggage in a crowded terminal. Additionally, passengers arriving at their destination are particularly anxious to collect their belongings and be on their way. They want to recognize their luggage quickly. This combination of similar labels and tags, similar luggage, and the rush to recover the luggage often leads to misidentified luggage resulting in lost, mistakenly identified or stolen luggage

In addition to the complications involved in recognizing and collecting luggage, there is the added stress of the travel experience in general. Domestic and international travel has become increasingly serious in that there are strict guidelines and restrictions placed on passengers in order to insure safe and secure travel. The process of checking in, going through security check points, traveling and collecting luggage at the point of destination can be daunting. The process of checking luggage should be quick, simple and efficient. However, that doesn't mean that it cannot be fun and interesting at the same time, while also serving a useful purpose in helping a passenger identify their particular piece of luggage.

Another complication for today's travelers resides in restrictions imposed on carry-on items. The restrictions have forced passengers to include m any more items than would normally be included in checked luggage, such as cell phones and laptop computers. Therefore, the risk and cost associated with a lost bag is increased for the passenger and the passenger carrier. Because passengers are checking in more items and more valuable items, tracking luggage is becoming more important. A lost bag in today's travel environment can be much more expensive to a passenger carrier and much more problematic than ever before. Identification and tracking are important considerations. Also as important, is an inventory of the luggage contents. A traveler is more inclined to recover the true value of the lost luggage if they have an accurate accounting of what is in the bag.

From the passenger's standpoint, there is a need to easily, quickly and accurately identify their particular bag from a group of similar luggage. There is also a need to lighten the atmosphere, and add some fun to the overall travel experience to improves a passenger's mental state during check-in at a point of departure and again while collecting luggage at a point of destination. Further, there is a need for a passenger to maintain an accurate accounting of a bag's inventory for current travel, as well as record-keeping for future documentation, future travel and potential repeat travel itineraries.

There is also a need for detailed and accurate tracking of passenger luggage by passenger carriers as present guidelines are changing for passenger carriers in that the carrier will have a greater financial responsibility for lost baggage. In the very near future, Radio Frequency Identification (RFID) will be used to track passenger luggage for the duration of a passenger's travel from point of departure, to point of destination and any stops therebetween for nearly if not all passenger carriers. May trials have been implemented and tested in the area of rail carriers, airlines and airports. The standardization and implementation of RFID technology in the travel industry will provide wide-ranging benefits for both passengers and carriers. However, some drawbacks, including the fact that the RFID tags have yet to be made available at a practical cost for passenger carriers, have delayed the implementation of RFID systems on a global scale.

Accordingly, it is desirable to dispense a label at a luggage check point while providing a passenger with a pleasant distraction from the serious nature of checking luggage and for the purpose of aiding in luggage recognition at a point of destination. In addition, it is desirable to dispense a ready-made, highly identifiable, disposable, re-usable, even rentable label that aids in recognition of a particular piece of luggage from a multitude of luggage. It is also desirable to provide a tracking device, such as an RFID device, in the label or tag for the purpose of tracking and tracing by the individual passenger and/or the passenger carrier. Other desirable features and characteristics of the present invention will become apparent from the subsequent detailed description and the appended claims, taken in conjunction with the accompanying drawings and the foregoing technical field and background.

### SUMMARY

The present invention provides an apparatus and a method for dispensing a luggage recognition label having an RFID or GPS device associated therewith that allows a passenger and/or a passenger carrier to identify and track luggage during travel, store and access travel information, and purchase travel insurance. The apparatus and method comprise the combination of features of the independent claims, preferred optional features being introduced by the dependent claims.

### DESCRIPTION OF DRAWINGS

The present invention will hereinafter be described in conjunction with the following drawing figures, wherein like numerals denote like elements.

FIG. 1 shows an embodiment of a luggage recognition label of the inventive subject matter;

FIG. 2A shows an embodiment of a luggage recognition label of the inventive subject matter;

FIG. 2B shows an embodiment of a disposable portion of a luggage recognition label

FIG. 2C shows an embodiment of a transponder that may be used in conjunction with the luggage recognition label and the disposable portion of the luggage recognition label;

FIG. 3 shows an embodiment of a luggage recognition label attached to a handle of an example piece of luggage;

FIG. 4 shows a cut-away side view of a dispensing apparatus of the inventive subject matter;

FIG. 5 shown an embodiment of a pre-packaged luggage recognition label of the inventive subject matter;

FIG. 6 shows possible communication links among a dispenser, a controller, a personal computer, a stand-alone kiosk, and a portable transponder;

FIG. 7 is an embodiment of a portable transponder for linking communication between two possible embodiments of RFID readers;

FIG. 8 is an embodiment of the inventive subject matter showing a combination portable transponder and RFID reader housed in a USB hardware device;

FIG. 9 is block diagram of a method of an embodiment of the inventive subject matter;

FIG. 10 is an example reader arrangement for application of an embodiment of the inventive subject matter in an airport setting;

FIG. 11 is a block diagram of a method of an embodiment of the inventive subject matter;

FIG. 12 is an example screen-shot of an interactive software program used in association with an embodiment of the inventive subject matter;

FIG. 13 is an example screen-shot of an interactive software program used in association with an embodiment of the inventive subject matter;

FIG. 14 is an example screen-shot of an interactive software program used in association with an embodiment of the inventive subject matter;

FIG. 15 is an example screen-shot of an interactive software program used in association with an embodiment of the inventive subject matter;

FIG. 16 is an example screen-shot of an interactive software program used in association with an embodiment of the inventive subject matter; and

FIG. 17 is an example of a screen-shot of an interactive software program used in association with an embodiment of the inventive subject matter.

Elements and steps in the figures are illustrated for simplicity and clarity and have not necessarily been rendered according to any particular sequence. For example, steps that may be performed concurrently or in different order are illustrated in the figures to help to improve understanding of embodiments of the present invention.

### DESCRIPTION OF INVENTION

While various aspects of the present invention are described with reference to a particular illustrative embodiment, the invention is not limited to such embodiments, and additional modifications, applications, and embodiments may be implemented without departing from the present invention. In the figures, like reference numbers will be used to illustrate the same components. Those skilled in the art will recognize that the various components set forth herein may be altered without varying from the scope of the inventive subject matter. The following detailed description is merely exemplary in nature and is not intended to limit the invention or the application and uses of the invention. Furthermore, there is no intention to be bound by any expressed or implied theory presented in the preceding technical field, background, brief summary or the following detailed description.

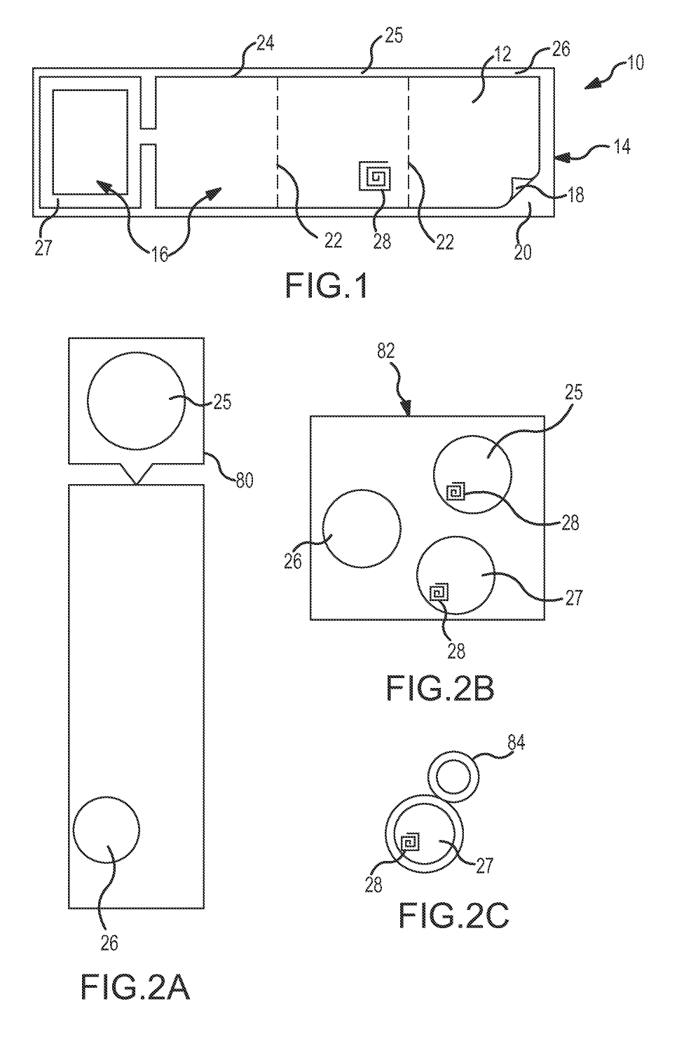

Referring to FIG. 1, a luggage recognition label 10 is shown. The term label may also be called a tag, key fob, card, disc, or the like. The label 10 has a front face 12 and a rear face 14. The front face 12 of the label 10 is a distinct design 16 such as a descriptive word, phrase, definition, picture, or symbol. The design 16 is presented in a size and color such that the label 10 is easily identifiable on a piece of luggage from a distance. The design 16 may also involve a specialized printing process, such as lenticular printing, to further enhance easy identification of individual luggage as described herein. Further, there may be a separate sheet of labels that may be dispensed and applied to the label 10 that will be described in another embodiment with more detail later herein. The rear face 14 of the label has an adhesive 18 applied thereto for attaching the label 10 to a piece of luggage. A backing material 20 is removably attached to the rear face 14 of the label so as to protect the adhesive until the time the label is peeled from the backing material 20. The backing material 20 may be removed manually, or in an automated fashion to be discussed in more detail later herein.

The label design 16 may include an alpha-numeric message, such as, but not limited to, a lighthearted comment, definition, inspirational message, or comic phrase. In the alternative, the label design 16 may be a distinctive pattern, logo, picture, or other image. It should also be noted that any combination of the designs is also a possibility. The label design 16 should be distinct enough such that a passenger can easily identify the label 10 on their particular piece of luggage without mistaking it for another label 10. In this regard, the labels will be dispensed in such an order that no two, or other such reasonable number, of labels will be dispensed after each other. The idea being a passenger will receive a label that is uniquely identifiable from another passenger's label so as to avoid confusion.

The label design 16 may be pre-printed before being dispensed to a passenger. In the alternative, the label may be printed on wholly or in part at the time a passenger checks-in for travel. For example, the label 10 may have a designated area on the front face 12 for personalization by either a printer, or by hand using a writing instrument such as a pen, pencil, marker, or the like.

The passenger may customize the label design at point-of-sale by way of interactive software displayed on a computer that communicates with a dispensing system (to be discussed later herein) prior to retrieval of the label 10. In the alternative, customization may occur by way of a website that interacts with the label dispensing system, such that the passenger may customize the label from the convenience of their own home or personal computer. In this embodiment, the passenger can use their own artwork, photos, etc. as the label design 16. As discussed above, the label 10 may be partially or entirely printed by a printer that is a part of a display apparatus to be discussed in detail hereinafter.

The label 10 may be segmented into more than one piece. Such as by die cut design, perforations 22 as shown in FIG. 1, or another likely means. The label 10 may have multiple sections 25, 26, 27 so that a passenger can affix the label 10 to different places on the luggage, i.e., different surfaces, so that the label can be seen regardless of the position of the luggage as it is unloaded from the passenger carrier at the passenger's point of destination. Furthermore, the label has a “take-away” section 27 that remains with the passenger. The “take-away” section 27 has a similar label design 22 to the label sections 25, 26 that are applied to the luggage so the passenger can reference the take-away section 27 to remind the passenger of the distinctive pattern and/or phrase they are looking for to identify their luggage upon arriving at their destination. The take-away section 27 may also have an area that displays travel information, telephone reference numbers, keepsake information, and the like. Although, this is one description of a take away section, there may be other areas on label 10 that maybe removed for the same purpose.

The label 10 may be constructed, partially or entirely, from materials including, but not limited to, paper, plastic, metal, wood, composite, recycled products, and the like. The label 10 may also include fragrance (i.e., scratch and sniff technology), glow-in-the-dark material and/or ink, phosphorescence, flavoring, reflective material and/or ink, sparkles, metallic shavings, but should not be limited to these listed effects. Additionally, the label 10 may be printed using specialized printing technologies including, but not limited to, lenticular printing which creates a 2-dimensional, 3-dimensional, flash, flip or motion graphics visual representation on the label itself.

Further, there may be multiple pieces, i.e., one or more, stickers or appliques that are dispensed separately, but in conjunction with the original purchase of label 10 as shown in FIGS. 2A, 2B and 2C. A receiving label 80, shown in FIG. 2A, is purchased one time, and is of a durable material so as to be re-used. The disposable label 82, shown in FIG. 2B, is dispensed at the point-of-sale and pieces 25, 26, and may have a take-away portion 27 that may be brightly colored or lenticularly pre-printed and may adhere to different areas or sections of the receiving label 80. The take away 27, dispensed as one of the additional pieces, may be affixed to a disc member 84, shown in FIG. 2C, constructed from plastic, metal, rubber and the like, attached to a key ring 86 to become a portable transponder as well as an visual identification take away linked to the passenger's luggage. The additional pieces may be circular, rectilinear, square, etc. with the possibility of having an RFID transponder 28 embedded into the additional piece.

In the re-usable embodiment of the label 10 as shown in FIG. 2B. The label 10 may be dispensed and assigned to a particular traveler for a particular period of travel for a rental fee. In the alternative, the passenger purchases the re-usable tag and it remains associated with that particular passenger for any travel. The only updates to the label would be to associate the travel carrier and destination information for each travel incident. Upon reaching the destination, the traveler may return the rented label 10 at which time, the label may be reset for dispensing and use by another traveler. In either embodiment, the label is dispensed to the passenger upon their payment, and associated with the passenger as well as their luggage.

In any embodiment, the label 10 may include an RFID transponder 28 to aid the passenger and the passenger carrier in tracking the luggage for the duration of the passenger's travels. In one embodiment, the RFID transponder 28 is a separate device embedded in the label material. In an alternative embodiment, the RFID transponder 28 is integral with the label 10 in that it may be printed using RFID ink. The technology of RFID is rapidly advancing and it should be noted that one skilled in the art is capable of substituting another type of RFID transponder 28 to the inventive subject matter discussed herein. For example, recent developments have produced RFID powder that is embedded in the material of the label, such as paper or plastic. Hereinafter, the RFID transponder 28 within the label 10 will be called a fixed transponder 28. Fixed in this sense means only that the RFID transponder is integrated into the label 10 that is attached to and remains with the luggage during the duration of travel. Fixed is by no means intended to mean permanent attachment. The fixed transponder 28 may be an ultra-high frequency (UHF) tag which is the standard being imposed in the airline industry for baggage tracking within the airport perimeter. However, the fixed transponder 28 should not be limited to this frequency.

The disposable label 10, 82 is designed to be used only once and can be thrown out after use because the RFID transponder 28 will no longer serve any purpose after the passenger has collected their luggage. However, the design of the label 10 is such that the passenger may desire to save, or collect, the luggage labels as memoirs of past travels. The label 10 is designed to be used once for functional purposes, yet they will have a collectible interest in its design. The label 10 may be tracked for keepsake and inventory by way of a website, network and/or software program as will be discussed in detail later herein.

Waste Electrical and Electronic Equipment (WEEE) directive from the European Commission has adopted a proposal for a restriction on the use of certain hazardous substances in electrical and electronic equipment. The proposed directive specifies that devices relying upon electronic current or electro-magnetic fields as a source of power must be sorted and recycled. RFID technology applied to labels does not require electrical or electronic components to fulfill their primary function, and therefore, are not subject to the proposed directive, rendering them disposable without the need for recycling. The labels 10 of the inventive subject matter pose no environmental concern as stated in the International Air Transport Association RFID Business Case Report, 2007. The United States Department of Transportation has looked to this directive thus far, however, as regulations may change in time with more information gathering, these guidelines may not hold true and other procedures may need to be reviewed and possibly implemented.

The re-usable label is assigned to a traveler and their bags at the point the bag is being checked into or dropped off at the carrier using an RFID reader in communication with the RFID tag and transponder. Upon reaching the destination, the traveler returns the label 10 at which time, the RFID transponder 28 in the label may be reset for dispensing, assignment and use by another traveler. In the alternative, a traveler may be assigned a permanent number that is associated with their travel information and therefore, the same tag may be used by the same traveler over and over again. The label is re-assigned at the point of checking the luggage in order to track the bag between departing and arriving destinations.

The label 10 is not intended to permanently attach to the luggage. Therefore, in the disposable embodiment, the strength of the adhesive 18 should adequately hold the label 10 to the luggage 21 for the duration of the travel, yet be easily removed by the passenger. The adhesive 18 should be dilute enough to easily peel the label 10 from the luggage 21 so as to maintain its full shape and configuration to be maintained as a collectible if desired once the label 10 has served its intended purpose. Further, the adhesive 18 should be dilute enough to not leave a residue on the luggage 21 or otherwise damage the luggage 21 upon removal of the label 10. The re-usable label embodiment will have an attachment mechanism that will securely fix the label 10 to the luggage, yet is capable of being removed upon reaching the traveler's final destination.

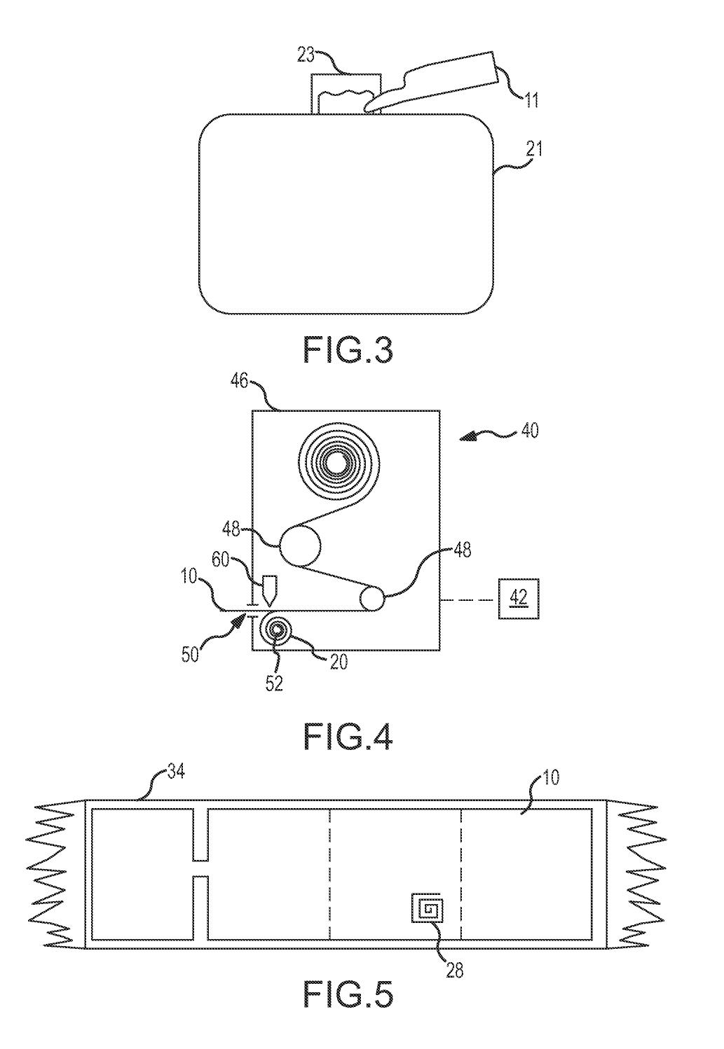

The shape of the label 10 may vary as desired, and may vary as necessary based on many factors. The label 10 may be die-cut in numerous shapes, sizes and configurations as shown in FIGS. 1 and 2A-C. Furthermore, the label 10 may be attached as one piece to the luggage, or as a “tag” 11 that hangs from a handle 23, or other portion of the luggage. In this case the label 11 will be removable. The re-usable label will have a clasp or other attachment mechanism. The disposable label may have a predetermined shape that is folded over and held together by the adhesive backing as the label 11 hangs, as a loop, from a luggage handle 23 as shown in FIG. 3. The loop portion is free of adhesive so the label 11 hangs from the handle 23.

In the alternative, the label is a plastic, or other suitable material, that is re-usable. In one embodiment, the tag is purchased by, or assigned to a passenger and may be re-used with one or more passenger carriers. In another embodiment, the tag is rented by the passenger. The tag may be dispensed at one point of the passenger's travel, and the RFID code is assigned to the particular customer for that particular travel segment. Upon completion of the passenger's travel and re-claim of their luggage, the tag is deposited at a collection point, mailed in to a central processing location, or otherwise returned to the carrier, for re-use. The reusable tag may be regenerated and reassigned to a new passenger for a new travel segment.

The label 10 may dispensed at the point of departure as a passenger checks their luggage 21 with the passenger carrier. In one embodiment, shown in FIG. 4, the label is presented from a dispensing apparatus, hereinafter dispenser 40. The dispenser 40 is such that a plurality of labels 10 are contained within the dispenser 40 and each label 10 is dispensed from the dispenser 40 upon payment by a passenger. A payment mechanism 42 communicates with the label dispenser 40 such that, upon receipt of payment or payment verification as explained later herein, directly at the label dispenser, through a representative of the passenger carrier, or through a passenger carrier's electronic check-in software, a label is dispensed at the dispenser 40. This will be described in more detail later herein. The purchase may be completed using a credit card, a debit card, cash, or by way of a cellular phone.

Referring again to FIG. 4 and in a preferred embodiment, the passenger may see the labels within the dispenser 40 and be able to view the dispensing process as the label is being dispensed. The dispenser 40 has a housing 46 that is completely, or in-part, sheer, clear, frosted, or see-through, in that the labels 10 to be dispensed are visible within the dispenser 40 along with the mechanism 48, such as a motor, for dispensing the label 10. The passenger may be entertained by the mechanics of the mechanism 48, or other sounds, lighting, or movement within, attached to, or in proximity to the housing 46, as they purchase their label 10. The visual experience for the passenger is intended to entertain, intrigue, relax and de-stress the passenger. Further, the design of the label 10 adds to the excitement and entertainment of the experience.

The label 10 may be dispensed from the dispenser 40 as an individual item, adhesive back and all. In the alternative, and as shown in FIG. 4, the label is dispensed at an opening 50, partially peeled from the backing material 20, such that the passenger pulls only the label 10 from the opening 50 and the backing material 20 is re-wound, as on a spool 52, within the dispenser housing 46 for removal at a later time. This prevents the need for the passenger to peel the label 10 from the backing material 20 in order to attach the label 10 to the luggage. This alternative saves time at the dispenser 40 as well as minimizes the potential for litter, disposal of the backing, and waste. In the re-usable embodiment, the tag is either purchased or rented by the passenger and dispensed as a single unit.

In another embodiment, an individual label 10 is dispensed by a representative of the passenger carrier either from a roll of labels, or in a prepackaged form as shown, by example, in FIG. 5. The label 10 is packaged in a disposable wrapper 34, preferably see-through or otherwise exposing all or a portion of the label 10 within the wrapper 34. In this embodiment, should the RFID transponder's identifier be used for purposes of the passenger carrier, the unique identifier should be assigned to the RFID transponder by the passenger carrier upon purchase of the label by the passenger. Passenger information will be entered outside of the label dispensing system 40 by way of interactive software in communication with a secured network. The rented, re-usable tag may also be dispensed by a representative of the passenger carrier.

A label 10 that is provided directly by the passenger carrier is particularly advantageous for passenger carriers that utilize RFID for baggage handling. The RFID transponder 28 may be read and associated with a particular passenger within a secure network by the passenger carrier for their purposes and the unique identifier may also be used by the passenger for their own purposes, many of which overlap with those of the passenger carrier.

Regardless of the dispensing method, the label 10 is dispensed upon payment by the passenger or upon recognition that payment has been processed prior to the passenger's arrival at the label dispensing apparatus. Pre-payment may be performed by way of a website, via cellular phone, retail outlet, or other area where access to a network is provided. In the alternative, payment is made directly to the passenger carrier, and the label is dispensed by a representative of the passenger carrier.

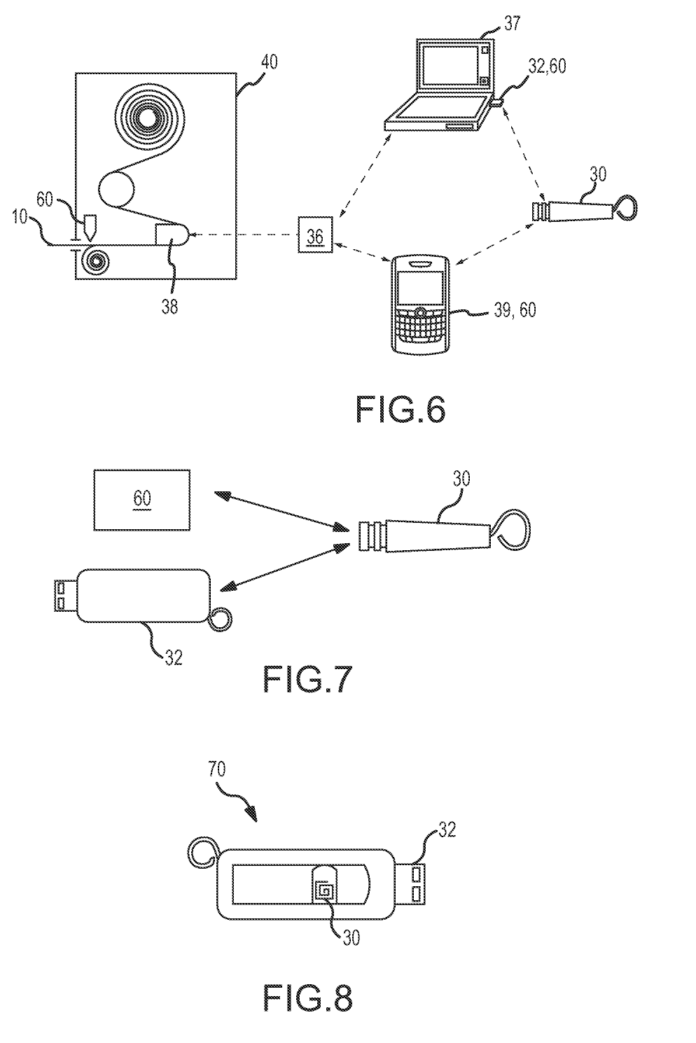

In yet another embodiment shown in FIG. 6, the individual label may be printed upon check-in with passenger carrier and passenger information. Along with passenger carrier information communicated by way of controller 36, may be printed on the label 10 from a printer 38 in communication with the passenger carrier system for luggage checking. The printer 38 may be located within, or near, the dispenser or may be a part of the passenger carrier system for luggage checking. Further, as discussed herein before, the printer may use RFID ink for printing the fixed transponder 28. In yet another embodiment, the label may be printed by the passenger from a personalized access website either within the airport or at another location, for example, from a remote computer 37 at the passenger's home printer. The label design may be customized by the passenger by either a printer or a handwriting instrument. The passenger may use their own artwork, photos, etc. to customize the label, or they may choose from a selection of possibilities. In the re-usable tag embodiment, the fixed transponder 28 is read and associated with the particular passenger and their luggage upon check-in with the passenger carrier.

In another embodiment, the controller 36 may be a programmable logic controller in communication with the passenger carrier's electronic check-in system may be located at baggage check-in points throughout the departure location. For example, kiosks 39 may be readily available throughout an airport and accessible by a passenger, for secure and limited communication with the passenger carrier by way of a secure network. This system allows the passenger to introduce their credit card, or other identification means, and check-in with the passenger carrier, make changes to a seat assignment, manage a reservation and print boarding passes and receipts. The controller interface will present a query to the traveler regarding the purchase of the luggage label 10. Should the passenger so desire, the controller will initiate dispensing of a label 10 upon verification of payment.

Referring again to FIG. 4, the dispensing apparatus 40 has the ability to read the unique code on the RFID transponder 28 that is available on the disposable label and communicate the association of the code to a particular passenger on the secure network. The transponder 28 is activated upon purchase at point of sale when a credit card is introduced into the dispenser for purchase of a label 10 or upon recognition of pre-payment of the label 10. Activation involves associating the unique identifier code in the transponder with the passenger before the label 10 is delivered to the customer. The transponder 28 in the label 10 contains only the unique identification code. No other information is stored on the RFID transponder. In this regard, the passenger is assured that travel information and other sensitive personal information, such as their credit card information, remains secure. Upon dispensing the label, the association of the unique identification code within the reader network allows access to and maintenance of information that will allow tracking of the passenger's bag.

An RFID reader 60, which may be fixed, portable, hand-held, or other configuration, is capable of recognizing the transponder's unique identification code. The reader 60 is shown within the housing of dispenser 40. However, it should be noted that the reader 60, or multiple readers 60, may be located throughout the passenger carrier area and will allow continuous tracking of the RFID label so that the passenger and the passenger carrier are aware of the location of the passenger's luggage at any point in time as will described in detail later herein.

The unique identification code of the fixed transponder 28 is associated with a passenger upon purchase of the label 10 and is communicated to the secure network system. Based on the address of the reader 60 communicating with the fixed transponder 28, a location for the luggage becomes known. Once the label 10 is in contact with any RFID reader 60 and identified within the secure network, the specifics of the luggage, the passenger, as well as other pertinent information becomes available on the secured network. The fixed transponder 28 carries only the unique identification code, which may be typically a number or combination of numbers, letters, and/or symbols, and represents a link to the present travel information within the network, and is used to track a travel experience from check-in, embarking, disembarking, and baggage retrieval.

The RFID reader 60, an example of which is shown in FIG. 4, not only reads the fixed transponder 28, it communicates the unique identification code on the fixed transponder 28, when the label 10 is purchased, to the secure network. The unique identification code is stored and maintained on the secure network as a link to the individual passenger's information. Many varieties of RFID readers exist and may be used in accordance with the inventive subject matter. Some examples include, but are not limited to stand-alone readers, hand-held readers, shelf-readers and many more too numerous to mention herein.

As discussed earlier herein, payment for the label or rental thereof, is through any known type of payment mechanism 42. The payment mechanism may be a machine read credit card reader, cash insertion, internet pre-payment or payment to the representative of the passenger carrier or via passenger carrier's electronic check in system. In another embodiment of the inventive subject matter, a portion of the proceeds of the sale of the label may be donated to a charity. The charity may be selected by the passenger, passenger carrier, the label vendor, or may even be selectable by the charity itself. The charity donation may be predetermined and applied at the time of purchase, or the passenger may have the option of selecting a charity of their choice from a selection of charities provided in the software program which is accessed using the portable transponder.

The fixed transponder 28 in label 10 becomes activated by an RFID reader on the network once confirmation is received that payment has been made. Upon confirmation, the fixed transponder 28 is exposed to the RFID reader, which may or may not be a part of the dispensing apparatus. In the embodiment shown in FIG. 4, the RFID reader 60 is located within the housing. The RFID reader may be integral with the dispensing apparatus, it may be in close proximity thereto, or it may be a hand-held or other type of unit by which the passenger carrier initiates exposure of the transponder for activation.

In addition to the fixed transponder 28 in label 10 that is attached to the luggage 21 being tracked, a portable transponder 30 may be available to communicate via the secured network. FIG. 7 shows an embodiment of the portable transponder 30, which is a hardware device such as a key fob. In yet another embodiment, shown in FIG. 8, the portable transponder 30 is integrated with a USB interface, the purpose of which will be discussed later herein. The portable transponder 30 may also attach to the passenger's mobile device, such as a cellular phone or personal digital assistant through a communications port on the mobile device.

In either embodiment the passenger holds the portable transponder 30, which is activated with a unique identification code assigned to the particular passenger, and not necessarily the current itinerary and the luggage associated therewith. However, because the fixed transponder 28 is linked to the passenger through the luggage label 10, the portable transponder 30 may be used by the passenger to access information regarding the luggage 21 and other information as well. Referring again to FIG. 6, the portable transponder 30 may be used, with secure network settings such as a password protect screen, to access the information on the secured network by way of an RFID reader 60, some of which will be linked with the fixed transponder 28 in the disposable label 10.

The portable transponder 30 may be operated at a low frequency, as opposed to the UHF fixed transponder 28. The portable transponder 30 allows the passenger to maintain a personal travel account history through interaction with a software program, as by USB device 32, to be described later herein. When the portable transponder 30 is brought into close proximity to the RFID reader 60, the network may allow all, or part, of the passenger's personal account information to be viewed by way of an interactive program. The interactive program may also be accessed at locations such as point-of-sale locations within or outside of the passenger carrier perimeter. For example, retail luggage stores, restaurants, gas stations, home computers and the like. Access may be through a website or a cellular system.

The portable transponder 30 may also be used with USB device 32 that includes an RFID reader 32 (see FIGS. 6 and 7). In the alternative, the portable transponder may communicate with a kiosk 39 having a reader 60 therein, or other permanent or portable reader, that enables the passenger to privately access their itinerary and other information via the software program.

Referring again to FIG. 8, an embodiment 70 in which the portable transponder 30 and the RFID reader/USB device are integrated in a single unit. This is particularly advantageous in that a passenger need not carry a transponder and a USB device individually. The necessary hardware for reading an RFID transponder and accessing a secured network are combined in one unit making it very convenient for the passenger. This combined unit may be extremely useful in other applications, including but not limited to, access to networks for customization of any dispensed items, such as cosmetics, vitamin supplements, vitamin water and the like as the device reads a unique identifier, and accesses a user's individual account, which contains all relevant information, recipes, preferences, etc.

Directly relating to the travel industry, the private access to a secured network via portable transponder 30 may include passenger account information such as hotel reservations, past, present and future, flight (or other carrier) reservations, excursions, theater performances, amusement park passes, locations and operating hours, dinner reservations, etc. Further organizational tools may be provided in the software program for the passenger including an inventory of items packed, a checklist for items specifically needed for domestic and/or international travel, a travel destination history, interactive budgeting for vacation planning, emergency contact information and much more. This aspect of the inventive subject matter will be described in more detail later herein.

As of the writing of this patent, the use of RFID transponders has been approved for certain uses in the airline and other travel industries. While not yet approved for use on aircraft, GPS devices may also be employed as a means to track the luggage. In this embodiment, the passenger may use their cellular telephone, personal digital assistant, or other GPS receiver device to track the bag by way of a GPS signal being sent from the tag on the luggage. The passenger may receive location information as the GPS beacon sent from the tag is identified using a GPS system in place, or soon to be launched, such as the United States GPS, Europe's Galileo GPS program and Russia's GLONASS system, with China not far behind with systems such as Beidou-2 or Compass. So the carrier not only tracks the bag, but the passenger may personally track their bag through the travel process as well.

In accordance with one aspect of the inventive subject matter, a passenger may have access to future designs for label logos when accessing their personal itinerary through the key fob/portable transponder and software configuration. Further, the logos and designs on the label 10 may be limited edition, correlated to destination cities, correlated to passenger carriers, internet travel site partners, retail partners or personalized, thereby rendering the label collectible. As discussed above, no information is stored on the label other than the unique identifier assigned to the RFID transponder 28 that identifies that label 10 within an RFID reader network. Therefore, a lost or stolen label 10 is worthless and there is no threat to private information being extracted from the label 10 itself.

The passenger's portable transponder 30 may be linked to a reader device, such as a fixed reader processor means, or a personal computer having a reader, such as the USB device 32, 70, so that sensitive information related to the unique identifier code remains private as well. Just as the only link between the passenger and the RFID transponder 28 on the label 10 is through the unique identifier assigned to the RFID transponder 28, the portable transponder 30 only stores a unique identifier associated with a passenger and access to sensitive information is by way of the secure network. The portable transponder 30 does not store any personal information thereon and is used in conjunction with the software program which prompts the passenger to enter a password, further securing the passenger's information. Therefore, in the event the portable transponder is lost or stolen, a passenger is assured of privacy and security of private information.

The portable transponder 30 allows a passenger private access to the secure network, which may include past, present, and future information such as hotel reservations, flight reservations, excursions, theater performances, amusement park passes, locations and operating hours, dinner reservations, etc. Further, organizational tools may be provided in the software program, available via the secure network or a website, for the passenger including an inventory of items packed, a checklist for items specifically needed for domestic and/or international travel, a travel destination history, interactive budgeting for vacation planning, emergency contact information, or other relevant and/or necessary information for travel and/or travel records. An interactive software link to the luggage label and passenger access may include, but is not limited to, maintenance of an accurate accounting of the bag's inventory for the current travel destination, record keeping for future documentation, present itineraries for travel, lodging, rental car, and like reservations, future travel information, and potential repeat travel information, excursions, dinner reservations, organizational tools, budgeting tools, and emergency contact information.

The transponders 28, 30 may be passive, anti-theft read only, EPC global Class Number 0; passive or active identification read/write, EPC global Class Number 1; passive or active data logging read/write, EPC global Class Number 2; or semi-passive/active-onboard sensing read/write EPC global Class Number 3. The technology is constantly evolving, and guidelines may change. Therefore, these tag numbers, reading/writing capabilities, frequencies, tag, and reader assignments are provided for example purposes only and are not intended to limit the application of the inventive subject matter presented herein.

Fixed transponder 28 and portable transponder 30 are able to communicate with the secured private network, yet each device is activated separately. As discussed above, the fixed transponder is a unique identification code assigned to a particular label affixed to a particular piece of luggage. The passenger information is on the network and each code for each piece of luggage will be linked to a particular passenger. The portable transponder is activated with a code that is linked to a particular passenger. Therefore, any use of the portable transponder will allow the passenger to see any and all codes and information linked thereto. For example, if the passenger checked three pieces of luggage, each piece will have its own unique identification code, yet all pieces will be linked to the same passenger. The network stores and maintains this information. The transponders 28 and 30 hold only a unique identification code.

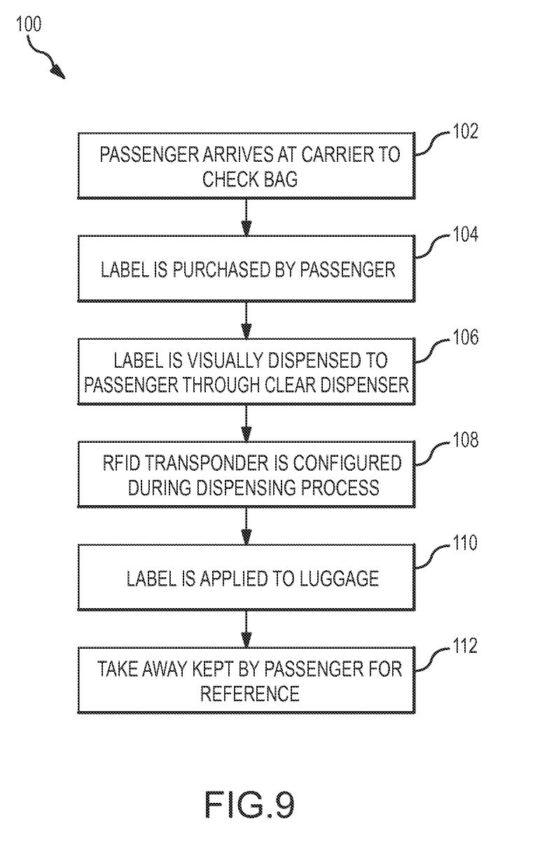

A method 100 of the present invention is shown in block diagram in FIG. 9. The method 100 is initiated when a passenger arrives at a departing terminal of a passenger carrier 102. The labels are presented, either by the physical location of a dispenser or by a representative of the passenger carrier, to the passenger for purchase. The passenger is presented with the option of purchasing or renting the distinctive label in order to aid in recognizing their own luggage upon arrival at their destination, along with the added bonus of making a donation to a worthwhile cause. The luggage recognition label is purchased or rented 104 by the passenger. The luggage recognition label is dispensed 106 to the passenger in a means that is visual to the passenger. More specifically, the dispensing mechanism is clear, see-through, frosted or sheer, in whole or in part, providing the passenger with a view of the label as it is being purchased and dispensed to the passenger at the point of sale. At the time of dispensing, any RFID transponder identification code on the label is communicated to the RFID reader, 108, which in turn initiates the dispensing process. It is this identification code that is read and linked to the passenger's information, which in turn is stored on the secured network. In the embodiment using GPS, the GPS transponder is activated and linked to the passenger at the point of sale.

The label is applied 110 to the luggage by the passenger before the luggage is released by the passenger with the passenger carrier for loading. The label “take-away” is kept by the passenger, in a location convenient to the passenger, such as on their boarding pass receipt, envelope, key fob portable transponder or other location. Upon arriving at their destination, the passenger can refer to the take-away as a reminder of the distinct design they are looking for on their particular luggage, and thereby quickly and easily identify 112 their luggage from the myriad of luggage being presented for collection by all the passengers.

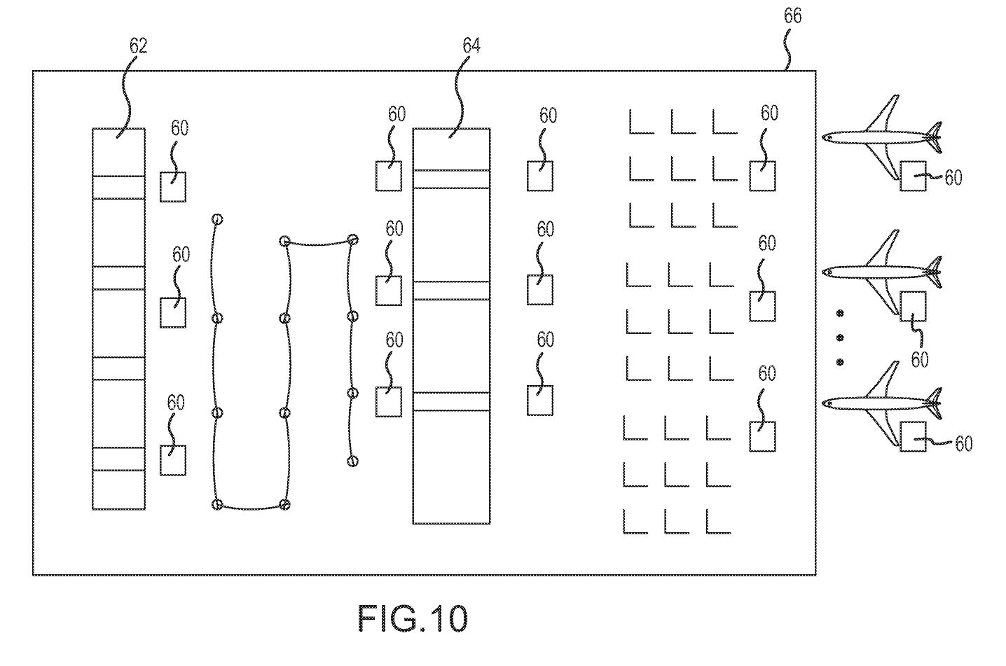

FIG. 10 shows a passenger carrier example of an airport with readers 60 strategically placed throughout the airport. The readers 60 may be in locations that are accessible to passengers so that a passenger can utilize the informational aspects of the inventive subject matter by way of the portable transponder 30. The readers 60 may also be located in places that are not accessible to passengers, such as outside of the airport at the gates, but are still strategically placed so that passenger carriers can easily identify and track baggage throughout their handling process. For example, readers 60 accessible to passengers and passenger carriers may be placed near check-in kiosks 62. Again, readers 60 may be available at a security check point 64. The readers 60 may also be available throughout the airport and at the gates 66 for the convenience of the passenger. Readers 60 accessible only to passenger carriers may be used outside of the gates to track the luggage as it is loaded into the plane. It should be noted that while an airport setting is shown in FIG. 9, this is for example purposes only and that it may be possible to apply the inventive subject matter in other passenger carrier settings.

In another embodiment, the readers are networked with each other so as to define a perimeter for actively reading the RFID transponder on the luggage label throughout the airport and associated gates, runways, etc. In yet another embodiment, the readers are placed at check-in kiosks and within the cargo hold of the plane such that a traveler can access information regarding the location of their bag on the airplane. The reader 60 on the plane will identify when the bag has been placed on and removed from the plane. A communication to the traveler may be made so that a traveler is assured of the location of their bag at any point in time from check-in, embarking at the point of departure, to disembarking at the point of destination.

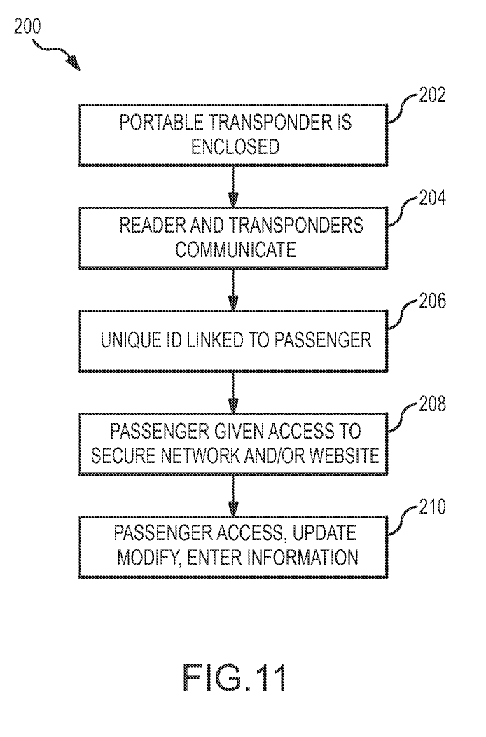

A method is described with the flow diagram shown in FIG. 11. The passenger's portable transponder, with its own unique identifier, is encoded 202 to the network by the reader. It is this process that links the transponder with the passenger. The encoding may take place at the dispenser unit or other reader location. Once encoded, the portable transponder 30 may be placed in communication 204 with any reader connected to the network, such as a USB reader at a personal computer (see FIG. 6) or a reader at a specialized station accessible to passengers within the passenger carrier terminal (see FIGS. 6 and 8). The reader will read 206 the unique identifier from the label and associate the identifier with the passenger's data 208. From the passenger's data, other information may be accessible 210 by the passenger to view and/or modify personal information.

The inventive subject matter is a software program designed to interface with the portable transponder 30 and a reader 60 at a personal computer or stand-alone kiosk. As discussed earlier herein, the reader reads the unique identifier stored on the portable transponder and links the passenger to a software program that may be used for accessing and planning their personal travel information. For example, the passenger is able to store past, present and future itineraries, access passenger carrier websites, make hotel reservations, make entertainment reservations such as purchasing theater, movie, exhibit and theme park passes. In addition, a passenger may make dinner reservations. The passenger can access data that includes entering an inventory of items packed in their luggage for this present itinerary or review past inventories to assist in current and future travel plans. The passenger may also access inventories for past trips in order to save from having to re-enter items that are packed on different trips.

The passenger's site will also include flight information and, if used in conjunction with a passenger carrier that utilizes RFID, may have access to real-time information about the location of their bag, which may be sent by way of text or voice message directly to a mobile phone when prompted or programmed to send a time message. In addition, flight status information may be accessible in real-time to passengers by way of the network/website system.

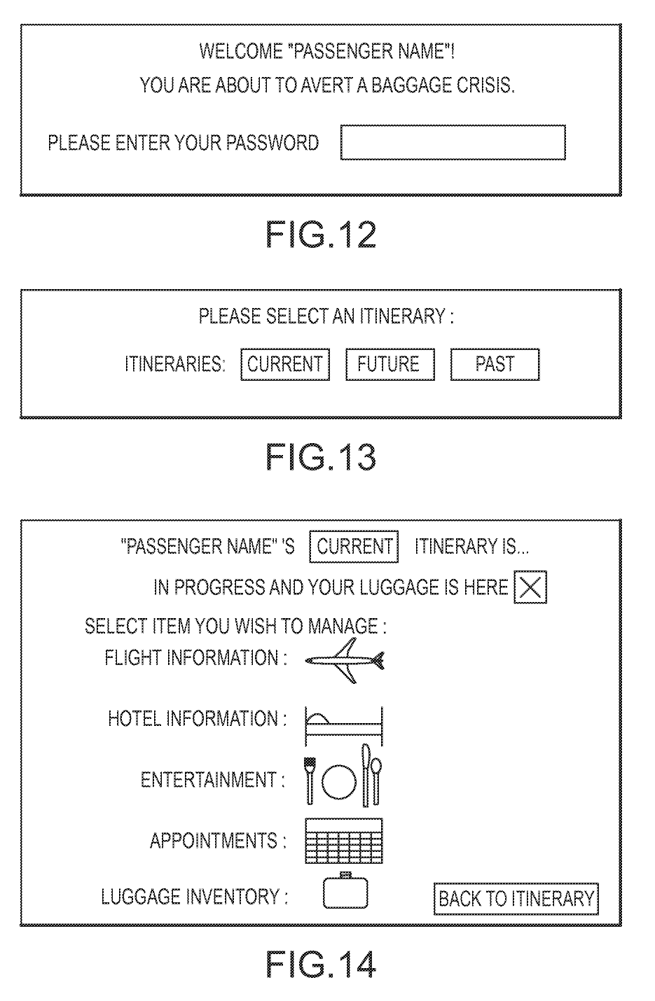

FIG. 12 is an example screen shot of the software program. The reader will read the identifier and present a welcome screen which identifies the passenger associated with the identifier and asks for a password to access the amenities of the software program.

FIG. 13 is an example screen shot of the ability for a passenger to select an itinerary for reference or manipulation. Selecting the “Current” itinerary will provide a selection of items to manage relating to the current itinerary as shown in FIG. 14 where a passenger can select a link to various information screens relative to specific aspects of their travel itinerary. While a flight itinerary is shown, it should be noted that the passenger carrier may be an airline, a railway, a cruise ship, a bus or car and an associated icon would be present depending on the nature of the passenger carrier.

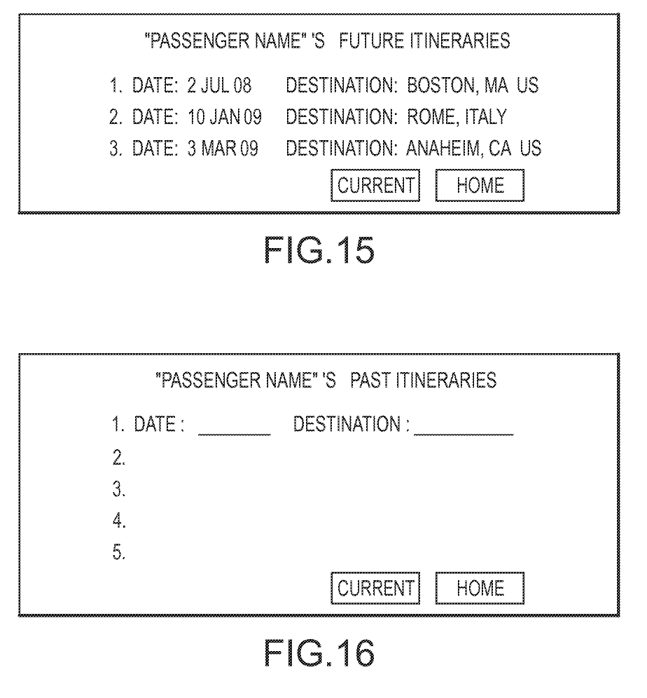

FIG. 15 shows an example of a “Future” itinerary screen where a passenger can preview an itinerary and access information screens relating to upcoming travel information, hotel reservations, entertainment options, calendar appointments and luggage inventory. Additional sections located in the “Future” itinerary screen may include interactive mapping destinations and weather updates.

FIG. 16 shows an example of a “Past” itinerary screen where a passenger can reference information screens relating to past flight information, past hotel information, past entertainment and calendar appointments and luggage inventory in the event a return trip is being made to a destination already traveled. Additional sections located in the “Past” itinerary screen may include a software program that may allow for downloading and sharing travel photographs from past trips.

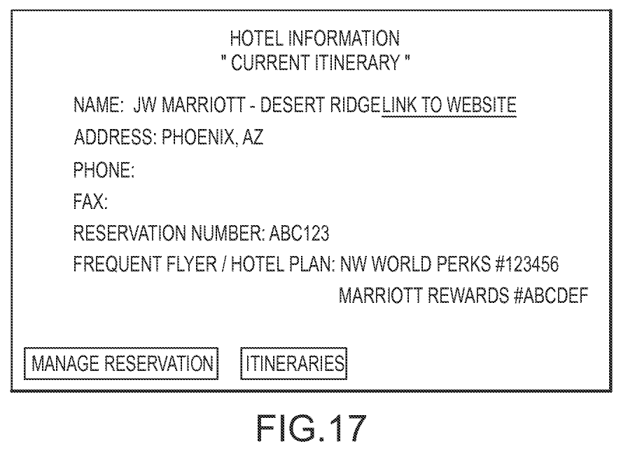

The information screens are accessible from the itinerary screens. Likewise the itinerary screens are accessible from the information screens. For example, selection of an icon in any of the Current, Future and Past itinerary screens, will direct the passenger to a screen relevant to that particular itinerary's information screen. In the event a passenger has chosen a “Future” itinerary, and “hotel information” has been selected, the passenger will be directed to the hotel reservation screen. See for example FIG. 17. The “hotel information” screen will provide the passenger with options relating to managing hotel reservations. Further, in the event a passenger wants to reference a past itinerary from the hotel information screen, that option is available as a link on the hotel information screen.

While several examples of data provided to the passenger from their personal site have been described herein, the list is anything but exhaustive. The possibilities for information and access are limited only by current technology in computer, Internet and database systems.

The portable transponder 30 will also have useful purpose in that it will identify a particular traveler. This may also be beneficial to a retail environment. For example, retailer's within an airport, train station, or cruise ship terminal may be able to easily receive payment from a portable transponder 30 associated with a particular passenger.

In the foregoing specification, the invention has been described with reference to specific exemplary embodiments. Various modifications and changes may be made, however, without departing from the scope of the present invention as set forth in the claims. The specification and figures are illustrative, rather than restrictive, and modifications are intended to be included within the scope of the present invention. Accordingly, the scope of the invention should be determined by the claims and their legal equivalents rather than by merely the examples described.

For example, the steps recited in any method or process claims may be executed in any order and are not limited to the specific order presented in the claims. The equations may be implemented with a filter to minimize effects of signal noises. Additionally, the components and/or elements recited in any apparatus claims may be assembled or otherwise operationally configured in a variety of permutations and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

The terms “comprise”, “comprises”, “comprising”, “having”, “including”, “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

1. A method for dispensing a luggage tag comprising the steps of:
accepting payment from a customer;
associating a luggage tag with the customer upon acceptance of the customer payment;
dispensing the luggage tag to the customer upon association of the luggage tag with the customer.

2. The method as claimed in claim 1 wherein the step of accepting payment further comprises accepting payment at a point of sale.

3. The method as claimed in claim 2 wherein the point of sale further comprises a passenger carrier point of departure.

4. The method as claimed in claim 3 wherein the passenger carrier is an airline.

5. The method as claimed in claim 3 wherein the passenger carrier is a cruise line.

6. The method as claimed in claim 3 wherein the passenger carrier is a rail line.

7. The method as claimed in claim 1 wherein the step of accepting payment further comprises accepting payment by way of an Internet website.

8. The method as claimed in claim 1 wherein the step of accepting payment further comprises accepting payment at a retail outlet.

9. The method as claimed in claim 1 wherein the step of associating a luggage tag with the customer further comprises the steps of:
creating a unique identification code on the luggage tag;
reading the unique identification code on the luggage tag; and
assigning the unique identification code to the customer.

10. The method as claimed in claim 9 wherein the step of creating a unique identification code further comprises printing a unique identification code using RFID ink.

11. The method as claimed in claim 1 wherein the luggage tag further comprises a unique identification code and the step of associating a luggage tag with the customer further comprises the steps of:
reading the unique identification code on the luggage tag; and
assigning the unique identification code to the customer.

12. The method as claimed in claim 11 wherein the luggage tag is a disposable luggage tag.

13. The method as claimed in claim 11 wherein the luggage tag is a re-usable tag and the method further comprises the steps of:
reclaiming the luggage tag at a predetermined destination upon completion of the customer travel;
processing the unique identification code on the luggage tag for clearing all association of the luggage tag with the customer; and
returning the luggage tag to a point of dispensing for re-use by another customer.

14. The method as claimed in claim 11 wherein the unique identification code is an RFID code.

15. The method as claimed in claim 14 further comprising the steps of:
reading the RFID code to identify the luggage and the customer associated therewith.

16. The method as claimed in claim 15 wherein the step of reading the RFID code further comprises reading the RFID code using a fixed RFID reader.

17. The method as claimed in claim 15 wherein the step of reading the RFID further comprises reading the RFID using a portable RFID reader.

18. The method as claimed in claim 17 wherein the customer carries a portable RFID reader for reading the RFID.

19. The method as claimed in claim 18 wherein the portable RFID reader is a USB device.

20. The method as claimed in claim 19 wherein the portable RFID reader is dispensed with the luggage tag.

21. The method as claimed in claim 18 wherein the portable RFID reader is dispensed separately from the luggage tag and is permanently associated with the customer, thereby allowing multiple luggage tags to be associated therewith.

22. The method as claimed in claim 11 wherein the disposable luggage tag is removably attached to the luggage.

23. The method as claimed in claim 22 wherein the disposable luggage tag is removably attached to a handle on the luggage.

24. The method as claimed in claim 22 wherein the disposable luggage tag is removably attached to a surface of the luggage.

25. The method as claimed in claim 1 wherein the step of dispensing the luggage tag to the customer upon association of the luggage tag with the customer is performed at a vending machine.

26. The method as claimed in claim 1 wherein the step of dispensing the luggage tag to the customer upon association of the luggage tag with the customer is performed by a representative of the passenger carrier.

27. The method as claimed in claim 26 wherein the step of dispensing the luggage tag to the customer upon association of the luggage tag with the customer is printed by the representative of the passenger carrier.

28. The method as claimed in claim 26 wherein the step of dispensing the luggage tag to the customer upon association of the luggage tag with the customer is presented in a pre-packaged form to the customer by the representative of the passenger carrier.

29. The method as claimed in claim 11 further comprising the step of linking the customer to a secure network providing private access to customer information stored on and accessible on the secure network.

30. The method as claimed in claim 29 further comprising the step of accessing customer information that includes inventory information and maintenance, record keeping, itinerary information, rental car information, hotel information, emergency contact information, weather information, organizational tools, budgeting tools, photographs, and travel records.

31. The method as claimed in claim 30 wherein itinerary information includes past, present and future travel information, hotel reservations, flight information, excursions, amusement park passes, theater tickets, and dinner reservations.

32. The method as claimed in claim 1 wherein the step of accepting payment further comprises purchasing travel insurance.

33. The method as claimed in claim 18 further comprising the step of notifying a passenger of the location of their luggage as the unique identification code is read by any reader within range of the luggage tag.

34. The method as claimed in claim 33 wherein the step of notifying a passenger further comprises notifying a passenger by way of a text message.

35. The method as claimed in claim 33 wherein the step of notifying a passenger further comprises notifying a passenger by way of a voice message.

36. The method as claimed in claim 33 wherein the step of notifying a passenger further comprises notifying a passenger by way of an email message.

37. The method as claimed in claim 33 wherein the step of notifying a passenger further comprises notifying a passenger by way of notification on a Internet networking website.

38. The method as claimed in claim 33 wherein the step of notifying a passenger further comprises notifying a passenger by way of notification on an application for a cellular phone service.

39. The method as claimed in claim 33 wherein the step of notifying a passenger further comprises notifying a passenger by way of notification on a website.

40. The method as claimed in claim 39 wherein the website is a website for the passenger carrier.

41. The method as claimed in claim 14 wherein the unique identification code is associated with a GPS transponder.

42. An apparatus for dispensing a luggage tag having a unique identification code associated therewith, the apparatus comprising:
a housing having an opening therein for dispensing a luggage tag;
a plurality of luggage tags contained within the housing;
a controller for associating the unique identification code on the luggage tag with a customer that is receiving the luggage tag;
means for dispensing a single luggage tag at a time.

43. The apparatus as claimed in claim 42 further comprising a mechanism for receiving payment by a customer thereby activating means for dispensing a single luggage tag upon purchase by the customer and association of the unique identification code on the luggage tag with the customer.

44. The apparatus as claimed in claim 42 further comprising an RFID reader for reading a RFID code on the luggage tag and communicating the RFID code to the controller for associating the unique identification code on the luggage tag with the customer.

45. The apparatus as claimed in claim 42 wherein the luggage tag is a disposable luggage tag.

46. The apparatus as claimed in claim 45 wherein the disposable luggage tag is a material selected from the group consisting of; paper, plastic, metal, composite, wood, recycled products, or any combination thereof.

47. The apparatus as claimed in claim 42 wherein the luggage tag is a re-usable luggage tag.

48. The apparatus as claimed in claim 47 wherein the disposable luggage tag is a material selected from the group consisting of; paper, plastic, metal, composite, wood, recycled products, or any combination thereof.

49. The apparatus as claimed in claim 42 wherein the plurality of luggage tags further comprises a fixed RFID code portion that is removably attached to the luggage and a portable RFID code portion that is maintained by the customer for reference to the fixed RFID code portion.

50. The apparatus as claimed in claim 42 further comprising:
a plurality of portable readers wherein each portable reader is associated with a customer and more than one luggage tag may be associated with the portable reader;
the controller associating the portable reader with the customer and at least one luggage tag; and
means for dispensing further comprises means for dispensing the portable reader and at least one luggage tag.

51. The apparatus as claimed in claim 51 further comprising a printer for printing the disposable luggage tag.

52. The apparatus as claimed in claim 51 further comprising RFID ink for printing the disposable luggage tag.

53. The apparatus as claimed in claim 51 further comprising an interface to the controller for customizing an appearance of the luggage tag.

54. The apparatus as claimed in claim 42 wherein the housing further comprises at least a partial clear panel for the customer to see the means for dispensing.

55. A luggage tag comprising:
a unique identification code that is associated with a particular customer, a particular piece of luggage and a particular travel destination;
a first portion of the luggage tag having a transponder with the unique identification code for removable attachment to the luggage; and
at least a second portion of the luggage tag having a portable transponder with the unique identification code that stays with the customer for reference to the first portion of the luggage tag.

56. The luggage tag as claimed in claim 55 wherein the at least a second portion of the luggage tag further comprises an advertisement portion.

57. The luggage tag as claimed in claim 55 wherein the first and at least a second portion of the luggage tag are disposable.

58. The luggage tag as claimed in claim 57 wherein the disposable luggage tag is a material selected from the group consisting of; paper, plastic, metal, composite, wood, recycled products, or any combination thereof.

59. The luggage tag as claimed in claim 58 wherein the material may include an effect selected from the group consisting of; specialized printing effects, fragrance, phosphorescence, reflective material, and lenticular printing.

60. The luggage tag as claimed in claim 55 wherein the first and at least a second portion of the luggage tag are re-usable.

61. The luggage tag as claimed in claim 60 wherein the re-usable luggage tag is a material selected from the group consisting of; paper, plastic, metal, composite, wood, recycled products, or any combination thereof.

62. The luggage tag as claimed in claim 61 wherein the material may include an effect selected from the group consisting of; specialized printing effects, fragrance, phosphorescence, reflective material, and lenticular printing.

63. The luggage tag as claimed in claim 55 wherein the unique identification code is an RFID code.

64. The luggage tag as claimed in claim 55 further comprising an adhesive backing for removably attaching the tag to a surface of the luggage.

65. The luggage tag as claimed in claim 55 further comprising a die cut design for removably attaching the tag to a handle of the luggage.

66. The luggage tag as claimed in claim 65 further comprising an adhesive backing for removably attaching the tag to a handle of the luggage.

67. The luggage tag as claimed in claim 55 wherein the transponder is a GPS transponder.

68. The luggage tag as claimed in claim 55 wherein the transponder and the portable transponder are RFID.
